(19) United States
(12) Patent Application Publication
(10) Pub. No.: US 2016/0164808 A1
(43) Pub. Date: Jun. 9, 2016

(54) METHOD AND DEVICE FOR INSTANT MESSAGING

(71) Applicant: Xiaomi Inc., Beijing (CN)

(72) Inventors: Jinbin Lin, Beijing (CN); Kun Ma, Beijing (CN); Dalong Shi, Beijing (CN)

(21) Appl. No.: 14/798,425

(22) Filed: Jul. 13, 2015

Related U.S. Application Data
(63) Continuation-in-part of application No. PCT/CN2015/077856, filed on Apr. 29, 2015.

(30) Foreign Application Priority Data
Dec. 3, 2014 (CN) 201410727826.8

(51) Int. Cl. H04L 12/58

(52) U.S. Cl. CPC H04L 51/04; H04L 51/38

(57) ABSTRACT

A method for instant messaging includes: sending a prompt message in a group chat when a first member sends a new message in the group chat, the prompt message being configured to prompt all members in the group chat existence of a new message; receiving a read request configured to request reading of the new message to a second member in the group chat; and screening the read request according to a predefined rule so as to determine whether to allow the terminal device to display the new message. The present disclosure may accurately control which member in the group chat can obtain permission of reading new messages without creating a new group chat or a new topic, thus guaranteeing privacy and security of messages, greatly reducing operation complexity, increasing interestingness of group chat, and improving activity of group chat and user experience.

### CROSS-REFERENCE TO RELATED APPLICATIONS

This application is a Continuation-In-Part of International Application No. PCT/CN2015/077856 with an international filing date of Apr. 29, 2015, which is based on and claims priority to Chinese Patent Application No. 201410727826.8, filed on Dec. 3, 2014, the entire contents of which are incorporated herein by reference.

### TECHNICAL FIELD

The present disclosure generally relates to the field of communications, and more particularly, to a method and a device for instant messaging.

### BACKGROUND

In online chatting software (or an online messenger), group chat is a tool for multi-user chatting and messaging. After creating a group chat, the group chat creator may invite friends or people with common interests to chat within the group chat. Messages sent from a member in the group chat may be received by all other members in the group chat. Thus it is convenient and efficient for multi-user chatting. However, with increasing popularity of chatting software and increasing number of the group chat members, such a demand appears: a member sends a message in a group chat, but the member merely hopes a parts instead of all other members in the group chat to receive this message.

### SUMMARY

The present disclosure provides a method for instant messaging and a device thereof, which may reduce operation complexity in instant messaging with partial members in a group chat.

According to a first aspect of the embodiments of the present disclosure, there is provided a method for instant messaging in a first terminal device, including: requesting a server to send a prompt message in a group chat when a first member of the group chat inputs a new message through a group chat interface of the first terminal device, wherein the prompt message is configured to prompt all other members in the group chat existence of the new message; receiving a read request configured to request displaying of the new message to a second member in the group chat, wherein the read request is initiated by the second member according to the prompt message through a group chat interface of a second terminal device; and screening the read request according to a predefined rule so as to determine whether to allow the second terminal device to display the new message.

According to a second aspect of the embodiment of the present disclosure, there is provided a method for instant messaging in a server, including: generating a prompt message upon a request sent from a first terminal device of a first member in a group chat, wherein the prompt message is configured to prompt all other members in the group chat existence of a new message; sending the prompt message to the group chat; receiving a read request configured to request displaying of the new message to a second member of the group chat, wherein the read request is initiated by the second member according to the prompt message through a group chat interface of a second terminal device; forwarding the read request to the first terminal device; and receiving a message sent from the first terminal device after it is determined whether to allow the second terminal device to display the new message and forwarding the message to the second terminal device.

According to a third aspect of the embodiments of the disclosure, there is provided a first terminal device for instant messaging, including: a processor and a memory configured to store instructions executable by the processor. The processor is configured to perform: requesting a server to send a prompt message in a group chat when a first member of the group chat inputs a new message through a group chat interface of the first terminal device, wherein the prompt message is configured to prompt all other members in the group chat existence of the new message; receiving a read request configured to request displaying of the new message to a second member in the group chat, wherein the read request is initiated by the second member according to the prompt message through a group chat interface of a second terminal device; and screening the read request according to a predefined rule so as to determine whether to allow the second terminal device to display the new message.

According to a fourth aspect of the embodiments of the disclosure, there is provided a server for instant messaging, including: a processor and a memory configured to store instructions executable by the processor. The processor is configured to perform: generating a prompt message upon a request sent from a first terminal device of a first member in a group chat, wherein the prompt message is configured to prompt all other members in the group chat that a new message exists in the group chat; sending the prompt message to the group chat; receiving a read request configured to request displaying of the new message to a second member of the group chat, wherein the read request is initiated by the second member according to the prompt message through a group chat interface of a second terminal device; forwarding the read request to the first terminal device; and receiving a message sent from the first terminal device after it is determined whether to allow the second terminal device to display the new message and forwarding the message to the second terminal device.

According to the embodiments of the disclosure, selective group chat is realized. In other words, it is possible to accurately control which member in the group chat can obtain permission of reading new messages. Group chatting with a portion of members in the group chat may be achieved without establishing a new group chat or a new topic, thus guaranteeing privacy and security of messages, greatly reducing operation complexity, increasing interestingness of group chat, and improving activity of group chat and user experience.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic scenario of instant messaging according to an exemplary embodiment.

FIG. 2 is a flow chart showing a method for instant messaging according to an exemplary embodiment.

FIG. 3 is a flow chart showing a method for instant messaging according to another exemplary embodiment.

FIG. 4 is a flow chart showing a method for instant messaging according to another exemplary embodiment.

FIG. 5 is a flow chart showing a method for instant messaging according to another exemplary embodiment.

FIG. 6 is a flow chart showing a method for instant messaging according to another exemplary embodiment.

FIG. 7 is a flow chart showing a method for instant messaging according to another exemplary embodiment.

FIG. 8 is a block diagram showing an apparatus for instant messaging according to another exemplary embodiment.

FIG. 9 is a block diagram showing an apparatus for instant messaging according to another exemplary embodiment.

FIG. 10 is a block diagram showing an apparatus for instant messaging according to another exemplary embodiment.

FIG. 11 is a block diagram showing an apparatus for instant messaging according to another exemplary embodiment.

FIG. 12 is a block diagram showing an apparatus for instant messaging according to another exemplary embodiment.

FIG. 13 is a block diagram showing an apparatus for instant messaging according to another exemplary embodiment.

FIG. 14 is a block diagram showing a first terminal device for instant messaging according to an exemplary embodiment.

FIG. 15 is a block diagram showing a first terminal device for instant messaging according to another exemplary embodiment.

FIG. 16 is a block diagram showing a server for instant messaging according to an exemplary embodiment.

FIG. 17 is a block diagram showing a server for instant messaging according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

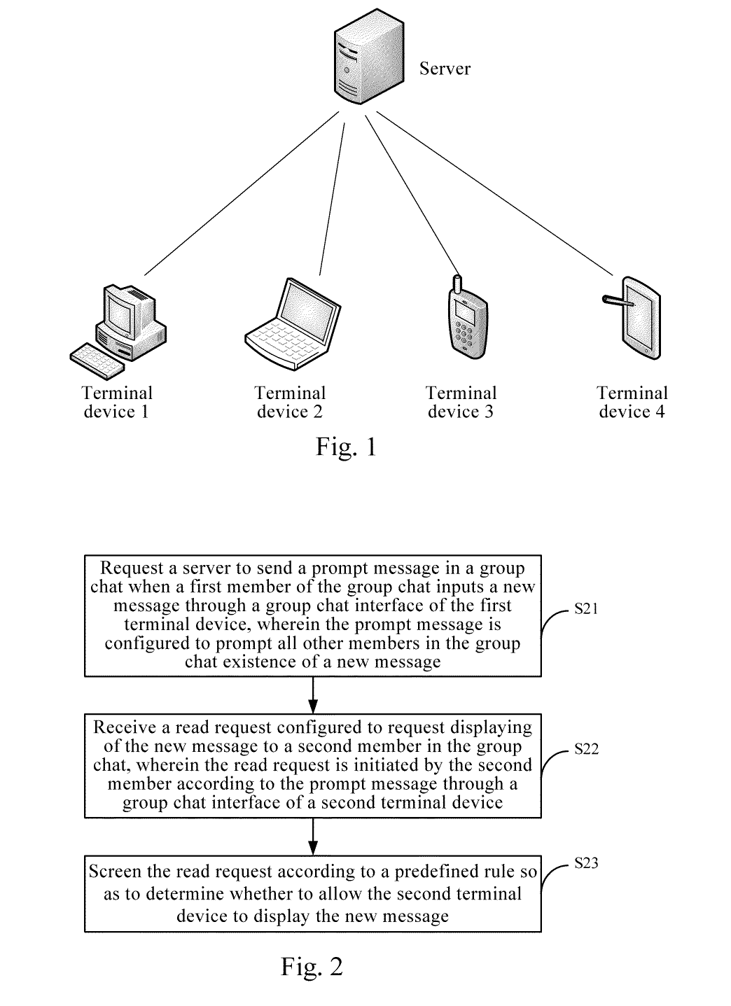

The embodiments of the present disclosure generally relate to a method and device for instant messaging, which are mainly applied in a scenario of group chat. The scenario may be implemented by an architecture shown in FIG. 1. Herein, elements of the architecture include a server and a plurality of terminal devices, illustrated by four terminal devices in FIG. 1. For example, the four terminal devices 1-4 may respectively be: a computer, a portable laptop, a mobile phone and a tablet computer. Terminal devices in the present disclosure may be terminal devices of any type, which is not limited herein. The terminal devices and the server are installed with instant messaging software through which instant messaging is available. Users of four terminal devices in FIG. 1 are in the same group chat, wherein any one of these four users may initiate a group chat to communicate with other users. In the embodiments of the present disclosure, instant messaging among partial members in a group chat is achieved by means of the method and device for instant messaging. A description will be made in detail as below.

FIG. 2 is a flow chart showing a method for instant messaging according to an exemplary embodiment. The method as shown in FIG. 2 is implemented by a first terminal device and includes following steps.

In Step S21, a server is requested to send a prompt message in a group chat when a first member of the group chat inputs a new message through a group chat interface of the first terminal device. Herein the prompt message is configured to prompt all other members in the group chat existence of the new message. According to the present disclosure, the first member of the group chat is a user of the first terminal device. When the first member is using an interface of a group chat application (such as a Wechat application), he may inputs a new message into the first terminal device. Then upon inputting the new message from the first member, the first terminal device will send a message to the server to inform the server that its user has inputted a new message. The server will be requested to send a prompt message in the group chat instead of directly sending the inputted new message in the group chat.

The prompt message may have multiple presentation forms, for example, an icon, a button or a link (or inter-linkage) and the like displayed on a group chat interface, on which the present embodiment makes no specific restriction. A second member of the group chat may send a read request to the server by clicking the prompt message. It should be noted that the prompt message contains no substantive message content and the prompt message may be received by all other members in the group chat except the first member who has inputted the new message.

In Step S22, a read request configured to request displaying of the new message to a second member in the group chat is received, the read request being initiated by the second member according to the prompt message through a group chat interface of a second terminal device. As described above, after inputting a new message, the first terminal device will send the control message to the server, and then the server will send a prompt message to all other members in the group chat. At least one of all other members will send a read request to the server and the server will forward the read request to the first terminal device. In other words, the first terminal device will receive the read request. Herein, the read request is configured to request displaying of the new message to one of all other members (the second member) in the group chat.

In Step S23, the read request is screened according to a predefined rule so as to determine whether to allow the second terminal device to display the new message.

Wherein, the new message is a message to be locally inputted from the user, including substantive content of the message, and the first member does not hope all other members in the group chat to receive the message. Therefore, a part of members in the group chat are selectively allowed to receive the message by means of the read request and acknowledge method.

In the present embodiment, optionally, the step of screening the read request according to a predefined rule so as to determine whether to allow the second terminal device to display the new message may include following substeps.

In substep 1, it is determined whether to allow the second terminal device to display the new message according to a local screening result.

In substep 2, the server is requested to send the new message to the second terminal device when it is determined to allow the second terminal device to display the new message.

In substep 3, the server is requested to send a rejection message to the second terminal device when it is determined to disallow the second terminal device to display the new message.

In the present embodiment, optionally, the step of determining whether to allow the second terminal device to display the new message according to a local screening result is implemented by the first terminal device and may include: inquiring the first member whether to allow the second terminal device to display the new message. For example, after displaying the read request to the user of the first terminal device (the first member), the first terminal device will input a user decision from the first member on whether to allow the second terminal device to display the new message.

Alternatively, the step of determining whether to allow the second terminal device to display the new message according to a local screening result is implemented by the first terminal device and may include: searching a preset whitelist or blacklist to determine whether to allow the second terminal device to display the new message. For example, the first terminal device will locally store a preset whitelist or blacklist and then search the whitelist or blacklist by using the name or identifier of the second member who sends the read request as an index. If the name or identifier of the second member is fallen into the preset whitelist, the first terminal device will decide to allow the second terminal device to display the new message. Otherwise, the first terminal device will decide not to allow the second terminal device to display the new message.

Alternatively, the step of determining whether to allow the second terminal device to display the new message according to a local screening result is implemented by the server and may include: searching a preset whitelist or blacklist to determine whether to allow the second terminal device to display the new message. For example, the server will store a preset whitelist or blacklist and then search the whitelist or blacklist by using the name or identifier of the second member who sends the read request as an index. If the name or identifier of the second member is fallen into the preset whitelist, the server will decide to allow the second terminal device to display the new message. Otherwise, the server will decide not to allow the second terminal device to display the new message.

Moreover, in some embodiments, the Step S21 (the step of requesting the server to send the prompt message) may include: sending a control message in a preset format to the server, wherein the control message is configured to instruct the server to send the prompt message in the group chat.

By implementing a selective group chat with the foregoing steps, the above method provided in the present embodiment may accurately control which member in the group chat can obtain permission of reading new messages without creating a new group chat or a new topic, thus guaranteeing privacy and security of messages, greatly reducing operation complexity, increasing interestingness of group chat, and improving activity of group chat and user experience.

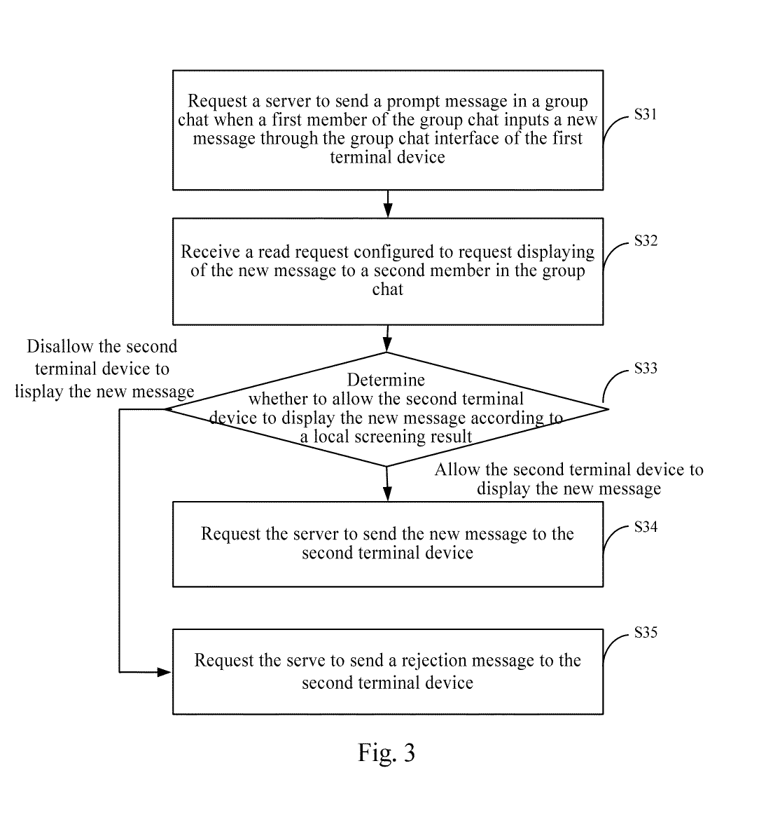

FIG. 3 is a flow chart showing a method for instant messaging according to another exemplary embodiment. As shown in FIG. 3, the method is implemented by a first terminal device, including following steps.

In Step S31, a server is requested to send a prompt message in a group chat when a first member of the group chat inputs a new message through a group chat interface of the first terminal device, wherein the prompt message is configured to prompt all other members in the group chat existence of the new message.

In Step S32, a read request configured to request displaying of the new message to a second member in the group chat is received, the read request being initiated by the second member according to the prompt message through a group chat interface of a second terminal device.

In Step S33, it is determined whether to allow the second terminal device to display the new message according to a screening result. Step S34 is executed if it is determined to allow the second terminal device to display the new message. Step S35 is executed if it is determined to disallow the second terminal device to display the new message.

The Step S33 may include following substep: inquiring the first member whether to allow the second terminal device to display the new message.

Alternatively, the Step 33 may include following substep: searching a preset whitelist or blacklist stored in the first terminal device to determine whether to allow the second terminal device to display the new message.

Alternatively, the Step 33 may include following substep: searching a preset whitelist or blacklist stored in the server to determine whether to allow the second terminal device to display the new message.

The following mode may be adopted to achieve the step of inquiring the first member whether to allow the second terminal device to display the new message: displaying “the member XX requests to read the message” on the group chat interface, providing an “Agree” button and a “Disagree” button to the first member for choice; determining that the second terminal device is allowed to display the new message if the first member clicks the “Agree” button, or is not allowed to display the new message if the first member clicks the “Disagree” button.

The whitelist is a list containing members who have permission to read a message. When the whitelist is used, a member listed in the whitelist has permission to read the message, and a member not listed in the whitelist has no permission to read the message.

The blacklist is a list containing members who have no permission to read a message. When the blacklist is used, a member listed in the blacklist has no permission to read a message, and a member not listed in the blacklist has permission to read a message.

In Step S34, the server is requested to send the new message to the second terminal device, and the then process ends.

The new message contains substantive content of the new message, and the user of the second terminal device may view the substantive content after receiving it.

In Step S35, the server is requested to send the rejection message to the second terminal device, and then the process ends.

The rejection message sent by the server will be displayed on the group chat interface of the member who is not allowed to displaying of the new message, thus achieving accurate control on which member in the group chat can obtain permission of reading new messages, and achieving the goal of chatting with a portions in the group chat.

According to one embodiment, the new message may be sent from the first terminal device to the server upon the new message is inputted into the first terminal device. The server will send the prompt message to all other members in the group chat instead of sending the new message to all other members in the group chat. Moreover, the server will temporarily store or reserve the new message. After it is determined to allow the second terminal device to display the new message by the first terminal device or the server, the server will send the new message to the second terminal device. Otherwise, the server will send the rejection message to the second terminal device. The rejection message may be created either by the server or by the first terminal device. If the rejection message is created by the first terminal device, the first terminal device will send the rejection message to the server and then the server will forward the rejection message to the second terminal device.

According to another embodiment, the new message may be sent from the first terminal device to the server after it is determined to allow the second terminal device to display the new message by the first terminal device or the server. Then the server will forward the new message to the second terminal device. If it is determined to not allow the second terminal device to display the new message, the server will send the rejection message to the second terminal device. The rejection message may be created either by the server or by the first terminal device. If the rejection message is created by the first terminal device, the first terminal device will send the rejection message to the server and then the server will forward the rejection message to the second terminal device.

By implementing a selective group chat with the foregoing steps, the above method provided in the present embodiment may accurately control which member in the group chat can obtain permission of reading new messages without creating a new group chat or a new topic, thus guaranteeing privacy and security of messages, greatly reducing operation complexity, increasing interestingness of group chat, and improving activity of group chat and user experience.

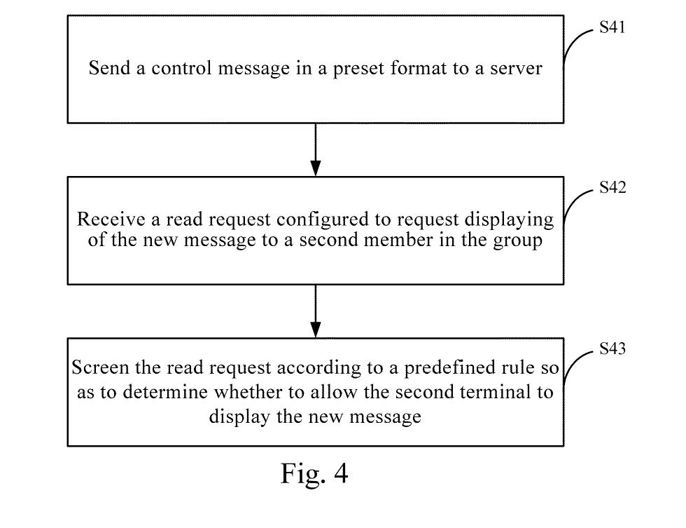

FIG. 4 is a flow chart showing a method for instant messaging according to another exemplary embodiment, and as shown in FIG. 4, the method is implemented by a first terminal device and includes following steps.

In Step S41, a control message in a preset format is sent to a server, wherein the control message is configured to instruct the server to send a prompt message in a group chat to prompt all other members in the group chat existence of a new message.

The server may send the control message as the prompt message to the group chat. Optionally, the content of the control message may be empty, i.e., the message contains no substantive content and is used solely for the purpose of prompt and acknowledgement. It should be noted that the control message is actually not the new message to be sent.

In Step S42, a read request configured to request displaying of the new message to a second member in the group chat is received, the read request being initiated by the second member according to the prompt message through a group chat interface of a second terminal device.

In Step S43, the read request is screened according to a predefined rule so as to determine whether to allow the second terminal device to display the new message.

By implementing a selective group chatting in a group chat with the foregoing steps, the above method provided in the present embodiment may accurately control which member in the group chat can obtain permission of reading new messages without creating a new group chat or a new topic, thus guaranteeing privacy and security of messages, greatly reducing operation complexity, increasing interestingness of group chat, and improving activity of group chat and user experience.

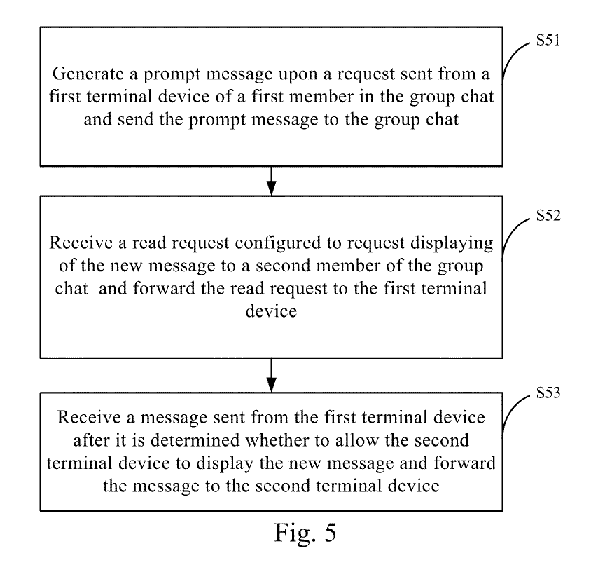

FIG. 5 is a flow chart showing a method for instant messaging according to another exemplary embodiment, and as shown in FIG. 5, the method is implemented by a server and includes following steps.

In Step S51, a prompt message is generated upon a request sent from a first terminal device of a first member in a group chat, and the prompt message is sent to the group chat, the prompt message being configured to prompt all other members in the group chat existence of a new message.

In Step S52, a read request configured to request displaying of the new message to a second member of the group chat is received, the read request being initiated by the second member according to the prompt message through a group chat interface of a second terminal device, and the read request is forwarded to the first terminal device.

The second member may be any other member except the first member in the group chat, which is not limited herein. The second member may click on the prompt message on his/her group chat interface to trigger sending of a read request to the first member, and the server may forward the read request to the first member.

In Step S53, a message sent from the first terminal device is received after it is determined whether to allow the second terminal device to display the new message, and the message is forwarded to the second terminal device.

In the present embodiment, optionally, the step S53 may include: the new message sent from the first terminal device is received after it is determined to allow the second terminal device to display the new message and forwarding the new message to the second terminal device.

Alternatively, the step S53 may include: a rejection message sent from the first terminal device is received after it is determined to disallow the second terminal device to display the new message and forwarding the rejection message to the second terminal device.

In the present embodiment, optionally, the step S51 may include: a control message in a preset format sent from the first terminal device in the group chat is received, and the prompt message is generated according to the control message. For example, the preset format may include a message with no content or a message with predetermined content such as “the read permission of the message is to be confirmed” and the like. The format of the control message may be predetermined by instant messaging software, on which the present embodiment makes no restriction.

By implementing a selective group chatting in a group chat with the foregoing steps, the above method provided in the present embodiment may accurately control which member in the group chat can obtain permission of reading new messages without establishing a new group chat or a new topic, thus guaranteeing privacy and security of messages, greatly reducing operation complexity, increasing interestingness of group chat, and improving activity of group chat and user experience.

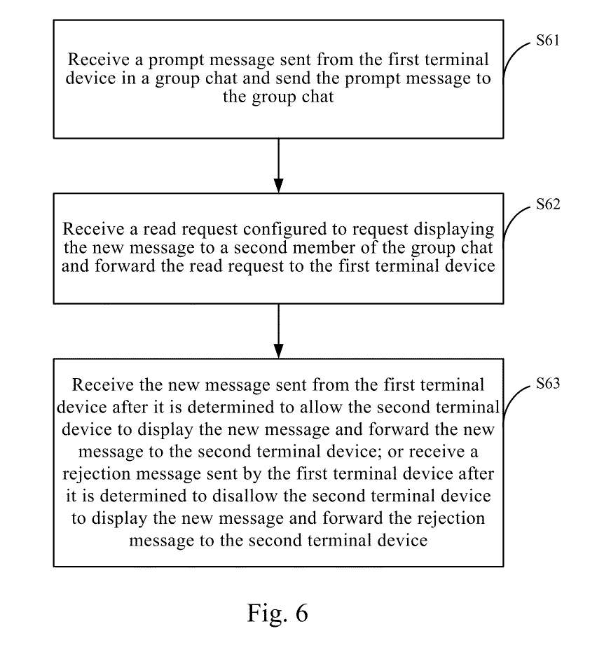

FIG. 6 is a flow chart showing a method for instant messaging according to another exemplary embodiment, and as shown in FIG. 6, the method is implemented by a server and includes following steps.

In Step S61, a prompt message sent from the first terminal device of a first member in a group chat is received, and the prompt message is sent to the group chat, the prompt message being configured to prompt all other members in the group chat existence of a new message.

In Step S62, a read request configured to request displaying of the new message to a second member of the group chat is received, the read request being initiated by the second member according to the prompt message through a group chat interface of a second terminal device, and the read request is forwarded to the first terminal device.

In Step S63, the new message sent from the first terminal device is received after it is determined to allow the second terminal device to display the new message, and the new message is forwarded to the second terminal device; or a rejection message sent from the first terminal device is received after it is determined to disallow the second terminal device to display the new message, and the rejection message is forwarded to the second terminal device.

For each member of the group chat sending a read request, the first member may control read permissions of the group chat according to the first member's own needs and determines whether to allow or disallow the member to read the message, thus achieving the goal of group chatting with a portion of members selected.

By implementing a selective group chatting with the foregoing steps, the above method provided in the present embodiment may accurately control which member in the group chat can obtain permission of reading new messages without establishing a new group chat or a new topic, thus guaranteeing privacy and security of messages, greatly reducing operation complexity, increasing interestingness of group chat, and improving activity of group chat and user experience.

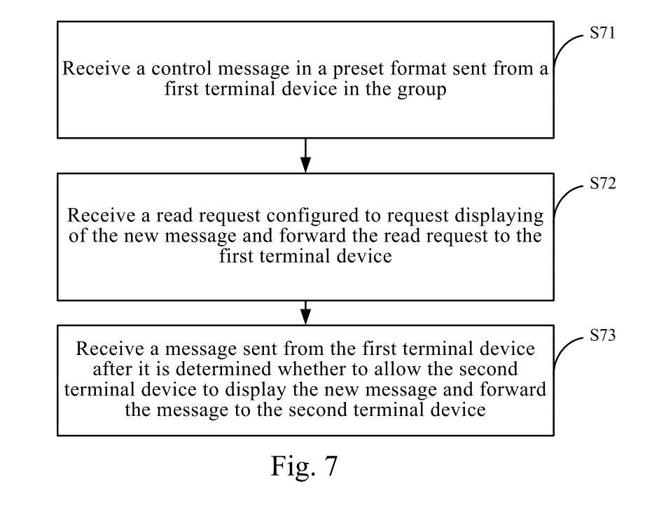

FIG. 7 is a flow chart showing a method for instant messaging according to another exemplary embodiment, and as shown in FIG. 7, the method is implemented by a server and includes following steps.

In Step S71, a control message in a preset format sent from a first terminal device of a first member in a group chat is received, wherein the control message is configured to instruct the server to send a prompt message in the group chat to prompt all other members in the group chat existence of a new message.

The prompt message may have multiple forms, for example, an icon shape like an envelope, a button or a link and the like, on which the present embodiment makes no specific restriction.

In Step S72, a read request configured to request displaying of the new message to a second member of the group chat is received, wherein the read request is initiated by the second member according to the prompt message through a group chat interface of a second terminal device, and the read request is forwarded to the first terminal device.

In Step S73, a message sent from the first terminal device is received after it is determined whether to allow the second terminal device to display the new message, and the message is forwarded to the second terminal device.

The message sent from the first member may be the new message or a rejection message. The message is forwarded by the server to the second member. Thus the read permission controlling of the second member is achieved.

By implementing a selective group chatting in a group chat with the foregoing steps, the above method provided in the present embodiment may accurately control which member in the group chat can obtain permission of reading new messages without establishing a new group chat or a new topic, thus guaranteeing privacy and security of messages, greatly reducing operation complexity, increasing interestingness of group chat, and improving activity of group chat and user experience.

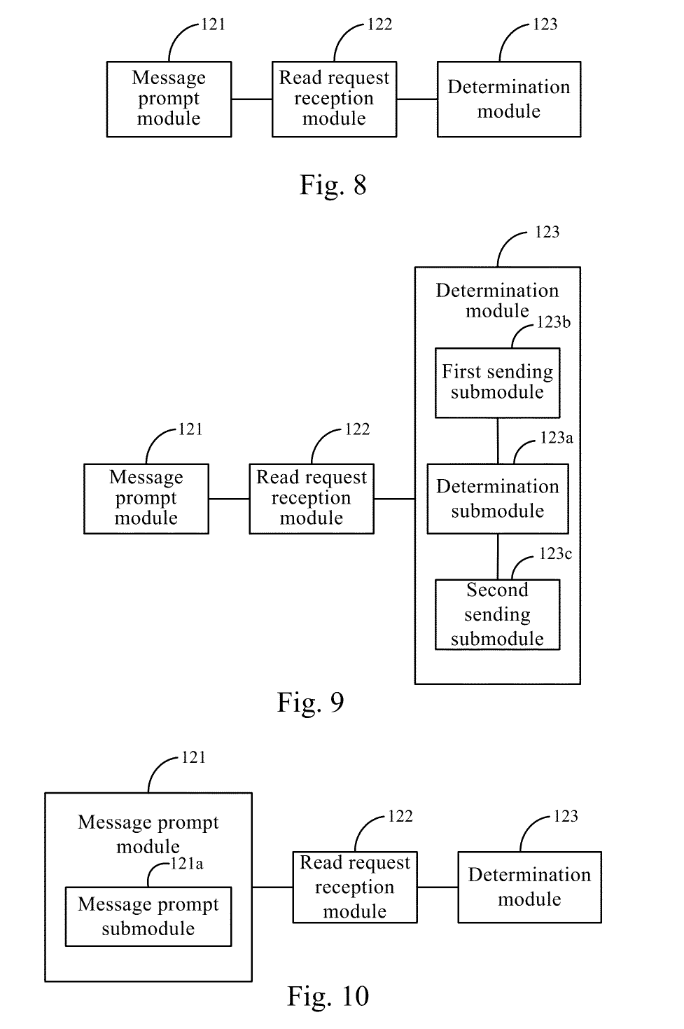

FIG. 8 is a block diagram showing an apparatus for instant messaging according to another exemplary embodiment. The apparatus is included in a first terminal device. Referring to FIG. 8, the apparatus includes a message prompt module 121, a read request reception module 122 and a determination module 123.

The message prompt module 121 is configured to request a server to send a prompt message in a group chat when a user of the group chat inputs a new message through a the group chat interface of the first terminal device, wherein the prompt message is configured to prompt all other members in the group chat existence of a new message.

The read request reception module 122 is configured to receive a read request configured to request displaying of the new message to a second member in the group chat, wherein the read request is initiated by the second member according to the prompt message through a group chat interface of a second terminal device.

The determination module 123 is configured to screen the read request according to a predefined rule so as to determine whether to allow the second terminal device to display the new message.

Referring to FIG. 9, in the present embodiment, optionally, the determination module 123 may include: a determination submodule 123a, a first sending submodule 123b and a second sending submodule 123c.

The determination submodule 123a is configured to determine whether to allow the second terminal device to display the new message according to a local screening result.

The first sending submodule 123b is configured to request the server send the new message to the second terminal device when the determination submodule determines to allow the second terminal device to display the new message.

The second sending submodule 123c is configured to request the server send a rejection message to the second terminal device when the determination submodule determines to disallow the terminal device to display the new message.

In the present embodiment, optionally, the determination submodule 123a is configured to inquire the first member whether to allow the second terminal device to display the new message, or search a preset whitelist or blacklist to determine whether to allow the second terminal device to display the new message.

Referring to FIG. 10, in the present embodiment, optionally, the message prompt module 121 may include a message prompt submodule 121a which is configured to send a control message in a preset format in a group chat to the server. The control message is configured to instruct the server to send the prompt message in the group chat. The prompt message is configured to prompt all other members in the group chat existence of a new message.

With regard to the device in the above embodiment, detailed description of specific modes for conducting operation of modules has been made in the embodiment related to the method and thus detailed illustration will be omitted herein.

By implementing a selective group chatting in a group chat, the foregoing device provided in the present embodiment may accurately control which member in the group chat can obtain permission of reading new messages without creating a new group chat or a new topic, thus guaranteeing privacy and security of messages, greatly reducing operation complexity, increasing interestingness of group chat, and improving activity of group chat and user experience.

FIG. 11 is a block diagram showing an apparatus for instant messaging according to another exemplary embodiment. The apparatus is included in a server. Referring to FIG. 11, the apparatus includes a message prompt module 221, a read request forwarding module 222 and a message forwarding module 223.

The message prompt module 221 is configured to generate a prompt message sent from a first terminal device in a group chat and send the prompt message to the group chat, wherein the prompt message is configured to prompt all other members in the group chat existence of a new message.

The read request forwarding module 222 is configured to receive a read request for displaying of the new message to a second member of the group chat. The read request is initiated by the second member in the group chat according to the prompt message through a group chat interface of the second terminal device. The read request forwarding module 222 is further configured to forward the read request to the first terminal device.

The message forwarding module 223 is configured to receive a message sent from the first terminal device after it is determined whether to allow the second terminal device to display the new message and forward the message to the second terminal device.

Referring to FIG. 12, in the present embodiment, optionally, the message forwarding module 223 may include a first forwarding submodule 223a or a second forwarding submodule 223b.

The first forwarding submodule 223a is configured to receive the new message sent from the first terminal device after it is determined to allow the second terminal device to display the new message and forward the new message to the second terminal device.

The second forwarding submodule 223b is configured to receive a rejection message sent from the first terminal device after it is determined to disallow the second terminal device to display the new message and forward the rejection message to the second terminal device.

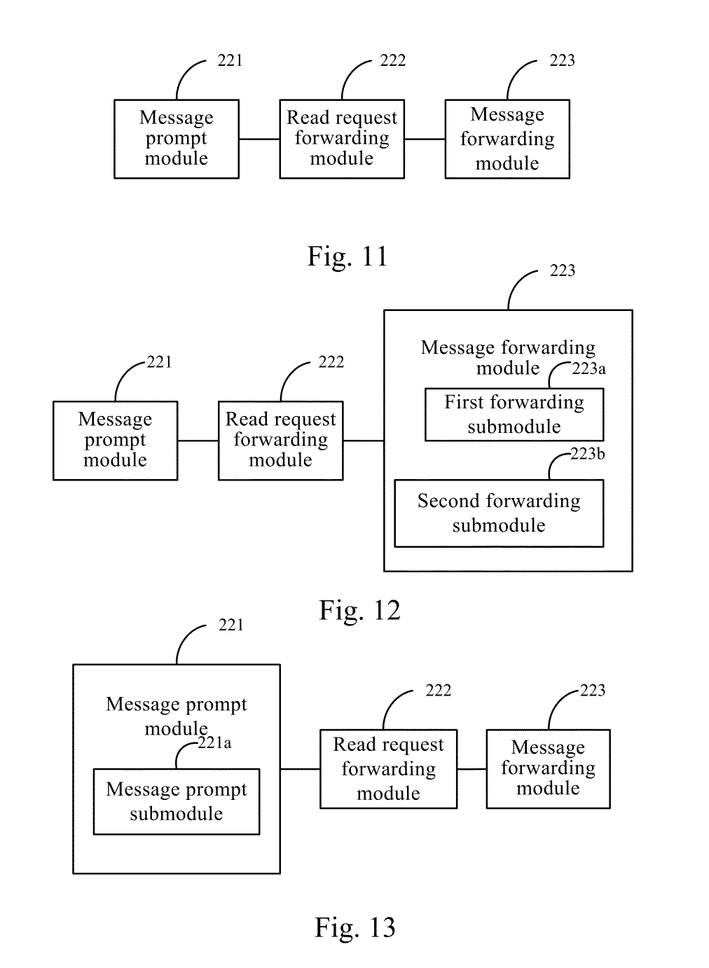

Referring to FIG. 13, in the present embodiment, optionally, the message prompt module 221 may include a message prompt submodule 221a which is configured to receive a control message in a preset format sent from the first terminal device in the group chat and generate the prompt message according to the control message, the prompt message being configured to prompt all other members in the group chat existence of a new message.

With regard to the device in the above embodiment, detailed description of specific modes for conducting operation of modules has been made in the embodiment related to the method and thus detailed illustration will be omitted herein.

By implementing a selective group chatting in a group chat, the foregoing device provided in present embodiment may accurately control which member in the group chat can obtain permission of reading new messages without establishing a new group chat or a new topic, thus guaranteeing privacy and security of messages, greatly reducing operation complexity, increasing interestingness of group chat, and improving activity of group chat and user experience.

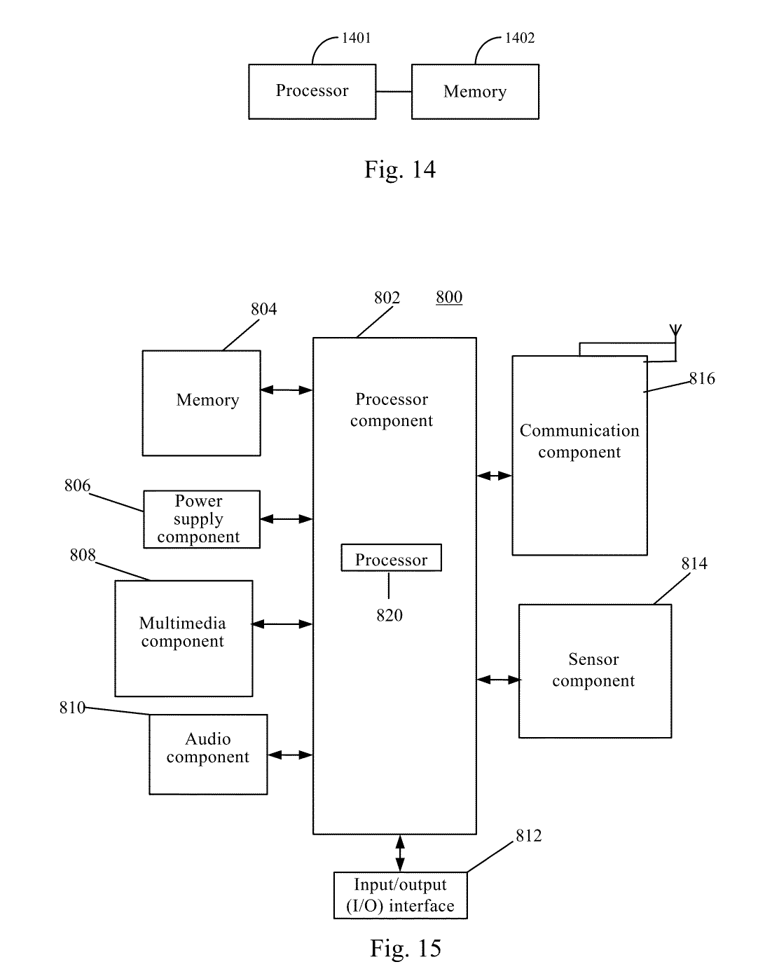

FIG. 14 is a block diagram showing a first terminal device for instant messaging according to an exemplary embodiment. Referring to FIG. 14, the device includes a processor 1401 and a memory 1402 configured to store instructions executable by the processor.

The processor 1401 is configured to performing: requesting a server to send a prompt message in a group chat when a first member of the group chat inputs a new message through a group chat interface of the first terminal device, wherein the prompt message is configured to prompt all other members in the group chat existence of the new message; receiving a read request configured to request displaying of the new message to a second member in the group chat, wherein the read request is initiated by the second member according to the prompt message through a group chat interface of a second terminal device; and screening the read request according to a predefined rule so as to determine whether to allow the second terminal device to display the new message.

FIG. 15 is a block diagram of a first terminal device 800 for instant messaging according to another exemplary embodiment. For example, the first terminal device 800 may be a mobile telephone, a computer, a digital broadcasting terminal, a message transceiver device, a games console, a tablet device, a medical device, a fitness facility, a PDA (personal digital assistant) and the like.

Referring to FIG. 15, the first terminal device 800 may include one or more components as below: a processor component 802, a memory 804, a power supply component 806, a multimedia component 808, an audio component 810, an input/output (I/O) interface 812, a sensor component 814 and a communication component 816.

The processor module 802 usually controls the overall operation of the first terminal device 800, for example, display, telephone call, data communication, and operation associated with camera operation and record operation. The processor component 802 may include one or more processors 820 for executing instructions so as to complete steps of the above method in part or in whole. In addition, the processor component 802 may include one or more modules for the convenience of interaction between the processor component 802 and other components. For example, the processor component 802 may include a multimedia module for the convenience of interaction between the multimedia component 808 and the processor component 802.

The memory 804 is configured to store data of different types so as to support the operation of the first terminal device 800. Examples of the data include instructions of any application program or method, contact data, phonebook data, message, picture and video, etc., which are operated on the first terminal device 800. The memory 804 may be realized by volatile or non-volatile memory device of any type or combination thereof, for example, static random access memory (SRAM), electrically erasable programmable read-only memory (EEPROM), erasable programmable read only memory (EPROM), programmable read-only memory (PROM), read-only memory (ROM), magnetic memory, flash memory, magnetic disk or optical disk.

The power supply component 806 provides power for components of the first terminal device 800. The power supply component 806 may include a power management system, one or more power supplies, and other components associated with generation, management and power distribution of the first terminal device 800.

The multimedia component 808 includes a screen between the first terminal device 800 and a user and for providing an output interface. In some embodiments, the screen may include an LCD (Liquid Crystal Display) and a touch panel (TP). If the screen includes a touch panel, the screen may be realized as a touch screen for receiving input signal from users. The touch panel includes one or more touch sensors for sensing gestures on the touch panel, for example, touching and sliding, etc. The touch sensor not only can sensor trip boundary of touching or sliding, but also can detect the duration and pressure related to the touching or sliding operation. In some embodiments, the multimedia component 808 includes a front-facing camera and/or a rear-facing camera. When the first terminal device 800 is under an operation mode, for example, capture mode or video mode, the front-facing camera and/or the rear-facing camera may receive external multimedia data. Each front-facing camera and rear-facing camera may be a fixed optical lens system or have focal length and optical zoom capacity.

The audio component 810 is configured to output and/or input audio signal. For example, the audio component 810 includes a microphone (MIC); when the first terminal device 800 is under an operation mode such as call mode, record mode and speech recognition mode, the microphone is configured to receive external audio signal. The audio signal received may be further stored in the memory 804 or sent out by the communication component 816. In some embodiments, the audio component 810 also includes a loudspeaker for outputting audio signal.

The I/O interface 812 provides interface for the processor component 802 and peripheral interface modules, the peripheral interface modules may be a keyboard, a click wheel and buttons, etc. These buttons may include but not limited to: home button, volume button, start button and locking button.

The sensor component 814 includes one or more sensors for providing the first terminal device 800 with state evaluation from all aspects. For example, the sensor component 814 may detect the on/off state of the first terminal device 800, relative positioning of components, for example, the components are the displayer and keypads of the first terminal device 800; the sensor component 814 also may detect the position change of the first terminal device 800 or a component thereof, the presence or absence of users' touch on the first terminal device 800, the direction or acceleration/deceleration of the first terminal device 800, and temperature variation of the first terminal device 800. The sensor component 814 may also include a proximity detector, which is configured to detect the presence of nearby objects in case of no physical touch. The sensor component 814 may also include an optical sensor, for example, CMOS or CCD image sensor for imaging. In some embodiments, the sensor component 814 may also include an acceleration sensor, a gyro sensor, a magnetic sensor, a pressure sensor, or a temperature sensor.

The communication component 816 is configured to facilitate wired communication or wireless communication between the first terminal device 800 and other equipment. The first terminal device 800 is available for access to wireless network based on communication standards, for example, WiFi, 2G or 3G, or combination thereof. In an exemplary embodiment, the communication component 816 receives by means of a broadcast channel the broadcast signal or broadcast-related information from external broadcast management systems. In an exemplary embodiment, the communication component 816 also includes a near field communication (NFC) module for promoting short-range communication. For example, the NFC module may be realized on the basis of Radio Frequency Identification (RFID) Technology, Infrared Data Association (IrDA) Technology, Ultra-wide Bandwidth (UWB) Technology, Bluetooth (BT) Technology and other technologies.

In exemplary embodiments, the first terminal device 800 may be realized by one or more application specific integrated circuits (ASIC), digital signal processors (DSP), digital signal processing equipment (DSPD), programmable logic devices (PLD), field programmable gate arrays (FPGA), controllers, microcontrollers, microprocessors or other electronic components, configured to execute the above methods.

In exemplary embodiments, a non-transitory computer-readable storage medium including instructions is also provided, for example, a memory 804 including instructions, above instructions may be executed by the processors 820 of the first terminal device 800 so as to achieve the above methods. For example, the non-transitory computer-readable storage medium may be ROM, random access memory (RAM), CD-ROM, magnetic tape, floppy disk and optical data storage device, etc.

There is provided a non-transitory computer-readable storage medium, wherein instructions in the storage medium are executed by the processor of the first terminal device so that the mobile terminal device may execute a method for instant messaging, and the method includes: requesting a server to send a prompt message in a group chat when a first member of the group chat inputs a new message through a group chat interface of the first terminal device, wherein the prompt message is configured to prompt all other members in the group chat existence of the new message; receiving a read request configured to request displaying of the new message to a second member in the group chat, wherein the read request is initiated by the second member according to the prompt message through a group chat interface of a second terminal device; and screening the read request according to a predefined rule so as to determine whether to allow the second terminal device to display the new message.

Optionally, the step of screening the read request according to a predefined rule so as to determine whether to allow the second terminal device to display the new message includes: determining whether to allow the second terminal device to display the new message according to a local screening result; requesting the server to send the new message to the second terminal device when it is determined to allow the second terminal device to display the new message; and requesting the server to send a rejection message to the second terminal device when it is determined to disallow the second terminal device to display the new message.

Optionally, the step of determining whether to allow the second terminal device to display the new message according to a local screening result includes: inquiring the user whether to allow the second terminal device to display the new message.

Alternatively, the step of determining whether to allow the second terminal device to display the new message according to a local screening result includes: searching a preset whitelist or blacklist to determine whether to allow the second terminal device to display the new message.

Optionally, the step of requesting the server to send the prompt message includes: ending a control message in a preset format to the server, the control message being configured to instruct the server to send the prompt message in the group chat.

By implementing a selective group chat, the foregoing non-transitory computer-readable storage medium provided in the present embodiment may accurately control which member in the group chat can obtain permission of reading new messages without establishing a new group chat or a new topic, thus guaranteeing privacy and security of messages, greatly reducing operation complexity, increasing interestingness of group chat, and improving activity of group chat and user experience.

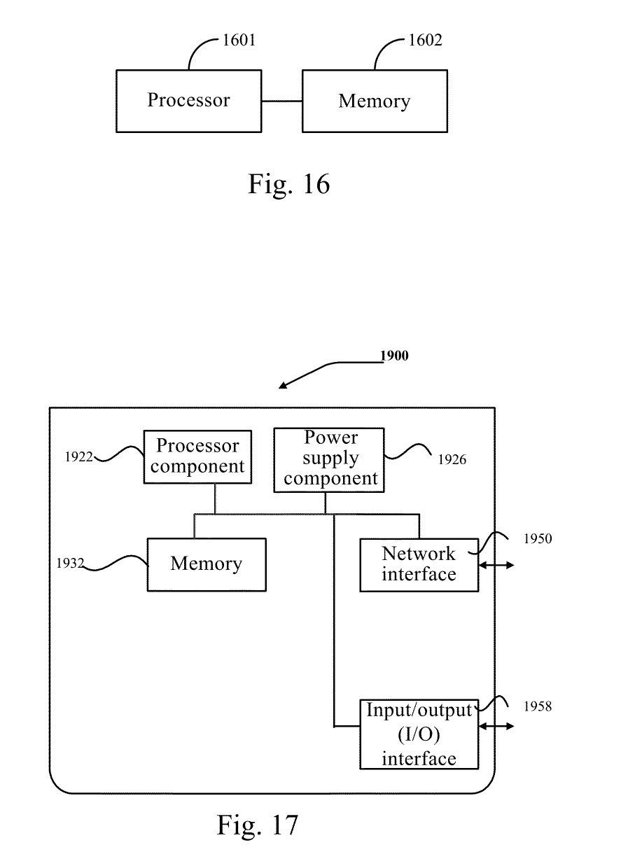

FIG. 16 is a block diagram showing a server for instant messaging according to an exemplary embodiment. Referring to FIG. 16, the server includes a processor 1601 and a memory 1602 configured to store instructions executable by the processor.

The processor 1601 is configured to perform: generating a prompt message upon a request sent from a first terminal device of a first member in a group chat, the prompt message being configured to prompt all other members in the group chat that a new message exists in the group chat; sending the prompt message to the group chat; receiving a read request for reading the new message configured to request displaying of the new message to a second member of the group chat, the read request being initiated by the second member according to the prompt message through a group chat interface of a second terminal device; forwarding the read request to the first terminal device; and receiving a message sent from the first terminal device after it is determined whether to allow the second terminal device to display the new message and forwarding the message to the second terminal device.

FIG. 17 is a block diagram of a server 1900 for instant messaging according to another exemplary embodiment. For example, the server 1900 may be provided as a server.

Referring to FIG. 17, the server 1900 includes a processor component 1922 which includes one or more processors, and memory resource represented by the memory 1932 configured to store instructions, for example, application program, executable by the processor component 1922. The application program stored in the memory 1932 may include one or more modules each of which is corresponding to a set of instructions. In addition, the processor component 1922 is configured to execute instructions so as to execute the foregoing method.

The server 1900 may also include a power supply component 1926 configured to execute the power management of the server 1900, a wired or wireless network interface 1950 configured to connect the server 1900 to the network, and an input/output (I/O) interface 1958. The server 1900 can operate an operating system based on and stored in the memory 1932, for example, Windows Server™, Mac OS X™, Unix™, Linux™, FreeBSD™ or other similar operating systems.

By implementing a selective group chat, the foregoing device provided in the present embodiment may accurately control which member in the group chat can obtain permission of reading new messages without newly establishing a group chat or a topic, thus guaranteeing privacy and security of messages, greatly reducing operation complexity, increasing interestingness of group chat, and improving activity of group chat and user experience.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for instant messaging in a first terminal device, comprising:
requesting a server to send a prompt message in a group chat when a first member of the group chat inputs a new message through a group chat interface of the first terminal device, wherein the prompt message is configured to prompt all other members in the group chat existence of the new message;
receiving a read request configured to request displaying of the new message to a second member in the group chat, wherein the read request is initiated by the second member according to the prompt message through a group chat interface of a second terminal device; and
screening the read request according to a predefined rule so as to determine whether to allow the second terminal device to display the new message.

2. The method of claim 1, wherein screening the read request according to the predefined rule so as to determine whether to allow the second terminal device to display the new message comprises:
determining whether to allow the second terminal device to display the new message according to a local screening result;
requesting the server to send the new message to the second terminal device when it is determined to allow the second terminal device to display the new message; and
requesting the server to send a rejection message to the second terminal device when it is determined to disallow the second terminal device to display the new message.

3. The method of claim 2, wherein determining whether to allow the second terminal device to display the new message according to the local screening result comprises:
inquiring the first member whether to allow the second terminal device to display the new message.

4. The method of claim 2, wherein determining whether to allow the second terminal device to display the new message according to the local screening result comprises:
searching a preset whitelist or blacklist to determine whether to allow the second terminal device to display the new message.

5. The method of claim 1, wherein requesting the server to send the prompt message comprises:
sending a control message in a preset format to the server, wherein the control message is configured to instruct the server to send the prompt message in the group chat.

6. A method for instant messaging in a server, comprising:
generating a prompt message upon a request sent from a first terminal device of a first member in a group chat, wherein the prompt message is configured to prompt all other members in the group chat existence of a new message;
sending the prompt message to the group chat;
receiving a read request configured to request displaying of the new message to a second member of the group chat, wherein the read request is initiated by the second member according to the prompt message through a group chat interface of a second terminal device;
forwarding the read request to the first terminal device; and
receiving a message sent from the first terminal device after it is determined whether to allow the second terminal device to display the new message and forwarding the message to the second terminal device.

7. The method of claim 6, wherein receiving the message sent from the first terminal device after it is determined whether to allow the second terminal device to display the new message and forwarding the message to the second terminal device comprises:
receiving the new message sent from the first terminal device after it is determined to allow the second terminal device to display the new message and forwarding the new message to the second terminal device.

8. The method of claim 7, wherein receiving the message sent from the first terminal device after it is determined whether to allow the second terminal device to display the new message and forwarding the message to the second terminal device comprises:
receiving a rejection message sent from the first terminal device after it is determined to disallow the second terminal device to display the new message; and
forwarding the rejection message to the second terminal device.

9. The method of claim 7, wherein generating the prompt message upon a request sent from the first terminal device of the first member in the group chat comprises:
receiving a control message in a preset format sent from the first terminal device in the group chat; and
generating the prompt message according to the control message.

10. A first terminal device for instant messaging, comprising:
a processor and a memory configured to store instructions executable by the processor;
wherein the processor is configured to perform:
requesting a server to send a prompt message in a group chat when a first member of the group chat inputs a new message through a group chat interface of the first terminal device, wherein the prompt message is configured to prompt all other members in the group chat existence of the new message;
receiving a read request configured to request displaying of the new message to a second member in the group chat, wherein the read request is initiated by the second member according to the prompt message through a group chat interface of a second terminal device; and
screening the read request according to a predefined rule so as to determine whether to allow the second terminal device to display the new message.

11. The first terminal device of claim 10, wherein screening the read request according to the predefined rule so as to determine whether to allow the second terminal device to display the new message comprises:
determining whether to allow the second terminal device to display the new message according to a local screening result;
requesting the server to send the new message to the second terminal device when it is determined to allow the terminal device to display the new message; and
requesting the server to send a rejection message to the terminal device when it is determined to disallow the terminal device to display the new message.

12. The first terminal device of claim 11, wherein determining whether to allow the terminal device to display the new message according to the local screening result comprises:
inquiring the first member whether to allow the second terminal device to display the new message.

13. The first terminal device of claim 11, wherein determining whether to allow the second terminal device to display the new message according to the local screening result comprises:
searching a preset whitelist or blacklist to determine whether to allow the second terminal device to display the new message.

14. The first terminal device of claim 10, wherein requesting the server to send the prompt message comprises:
sending a control message in a preset format to the server, wherein the control message is configured to instruct the server to send the prompt message in the group chat.

15. A server for instant messaging, comprising:
a processor and a memory configured to store instructions executable by the processor;
wherein the processor is configured to perform:
generating a prompt message upon a request sent from a first terminal device of a first member in a group chat, wherein the prompt message is configured to prompt all other members in the group chat that a new message exists in the group chat;
sending the prompt message to the group chat;
receiving a read request configured to request displaying of the new message to a second member of the group chat, wherein the read request is initiated by the second member according to the prompt message through a group chat interface of a second terminal device;
forwarding the read request to the first terminal device; and
receiving a message sent from the first terminal device after it is determined whether to allow the second terminal device to display the new message and forwarding the message to the second terminal device.

16. The server of claim 15, wherein receiving the message sent from the first terminal device after it is determined whether to allow the second terminal device to display the new message and forwarding the message to the second terminal device comprises:
receiving the new message sent from the first terminal device after it is determined to allow the second terminal device to display the new message and forwarding the new message to the second terminal device.

17. The server of claim 16, wherein receiving the message sent from the first terminal device after it is determined whether to allow the second terminal device to display the new message and forwarding the message to the second terminal device comprises:
receiving a rejection message sent from the first terminal device after it is determined to disallow the second terminal device to display the new message; and
forwarding the rejection message to the second terminal device.

18. The server of claim 16, wherein generating the prompt message upon a request sent from the first terminal device of the first member in the group chat comprises:
receiving a control message in a preset format sent from the first terminal device in the group chat; and
generating the prompt message according to the control message.
